(19) United States
(12) Patent Application Publication
(10) Pub. No.: US 2006/0055276 A1
(43) Pub. Date: Mar. 16, 2006

(54) Keyed motor brushes

(76) Inventor: Steven B. O'Donnell, Cerritos, CA (US)

Correspondence Address: AVERILL & VARN, 8244 PAINTER AVE., WHITTIER, CA, 90602, US

(21) Appl. No.: 10/943,428

(22) Filed: Sep. 16, 2004

(51) Int. Cl. H02K 13/00; H01R 39/38

(52) U.S. Cl. 310/239

(57) ABSTRACT

Round keyed brushes for electric motors. The brushes are formed from sintered material and the protruding key runs the length of the brush. The brush material is preferably carbon combined with copper and/or silver. Brush guides (or hoods) are screwed into an end bell, and keyways are then broached in the brush guides to properly align the round brushes. A braided copper shunt wire is centered in the round brush (i.e., co-axial) and runs substantially the length of the brush. The commutator contact surfaces are arced to match the commutator, and may be grooved to improve motor break-in.

### BACKGROUND OF THE INVENTION

The present invention relates to brushes for electric motors, and more particularly to round brushes, each having a key to rotationally align the brushes with a commutator.

Electric motors are used in many industrial, home, and recreational activities. In some applications, achieving high power from a small light motor is important, for example in radio control car racing. Many motors have been developed, sold, and raced, and several factors determine the value of such motors. These factors include performance, reliability, initial cost, and maintenance cost among others.

In order to achieve a high, or competitive, level of performance, a motor must include brush to commutator contact capable of conducting the greatest possible amount of current. The amount of current conducted is inversely proportional to the resistance between the brushes and the commutator, so reducing this resistance is very important. Known motors often experience undesirable motion and vibration of the brushes, which motion increases the resistance between the brushes and the commutator.

The result of increased resistance is an immediate loss of power, but also creates heat. Such heat reduces brush life, and may result in motor failure. For example, when the commutator reaches sufficient temperature, armature wire may come un-soldered from the commutator.

Various attempts have been made to improve the brushes, for example the Revolution (V2) motor made by Team Orion Performance Racing Products. The Revolution motor includes cylindrical brushes which are positioned at an angle other than 90 degrees away from the commutator, and claim a resulting performance advantage. Unfortunately, while some advantage may exist in this design, the result is costly to manufacture and difficult to maintain. For example, the motor is assembled by first loading the brushes into the end cap from the inside, and then assembling the motor, which is an awkward process.

Excess heat created by resistance between the brushes and the commutator may result in a need to replace brushes early or often, and as noted above, may in extreme cases, melt the solder attaching the armature windings to the commutator. Thus, maintenance and associated costs are increased when brush to commutator resistance increases.

### BRIEF SUMMARY OF THE INVENTION

The present invention addresses the above and other needs by providing round keyed brushes for electric motors. The brushes are formed from sintered material and the protruding key runs the length of the brush. The brush material is preferably carbon combined with copper and/or silver. Brush guides (or hoods) are screwed into an end bell, and keyways are then broached in the brush guides to properly align the round brushes. A braided copper shunt wire is centered in the round brush (i.e., co-axial) and runs substantially the length of the brush. The commutator contact surfaces are arced to match the commutator, and may be grooved to improve motor break-in.

In accordance with one aspect of the invention, there is provided an electric motor having a case, magnets residing in the case, an armature inside the case, and an end bell on one end of the case. The motor includes an improvement comprising round brush guides and round brushes adapted to slide axially within the brush guides and to be rotationally positioned by cooperation of keys with keyways. In one embodiment, the brushes include keys and the brush guides are screwed into the end bell, and after the brush guides are fixed in place, the keyways are formed in the brush guides by broaching, thereby establishing the proper orientation of the brushes. The brushes are preferably sintered and made from a combination of carbon combined with copper and/or silver. In another embodiment, the keys resides in the brush guides, and a keyway is formed on the brushes.

In accordance with another aspect of the present invention, there is provided a method for manufacturing a round keyed brush electric motor. The method comprising installing brush guides in a motor end bell, which brush guides include round brush holes, forming keyways in the brush holes, providing brushes having keys, and inserting the keyed brushes into the brush guides so that the keys cooperate with the keyways to align the brushes.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is an electric motor having round keyed brushes.

FIG. 2A is a perspective view of a round keyed brush.

FIG. 2B is a perspective view of a second round brush having a keyway.

FIG. 3A is a side view of the round keyed brush.

FIG. 3B is a top view of the round keyed brush.

FIG. 3C is a face view of the round keyed brush.

FIG. 4 is a cross-sectional view of the round keyed brush taken along line 44 of FIG. 3A.

FIG. 5A is an end view of a brush guide having a keyway.

FIG. 5B is an end view of a brush guide having a key.

FIG. 6 is a detailed view of an end bell with brush guides, and with the brushes shown removed from the brush guides.

FIG. 7 is a method for constructing a motor with round keyed brushes.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

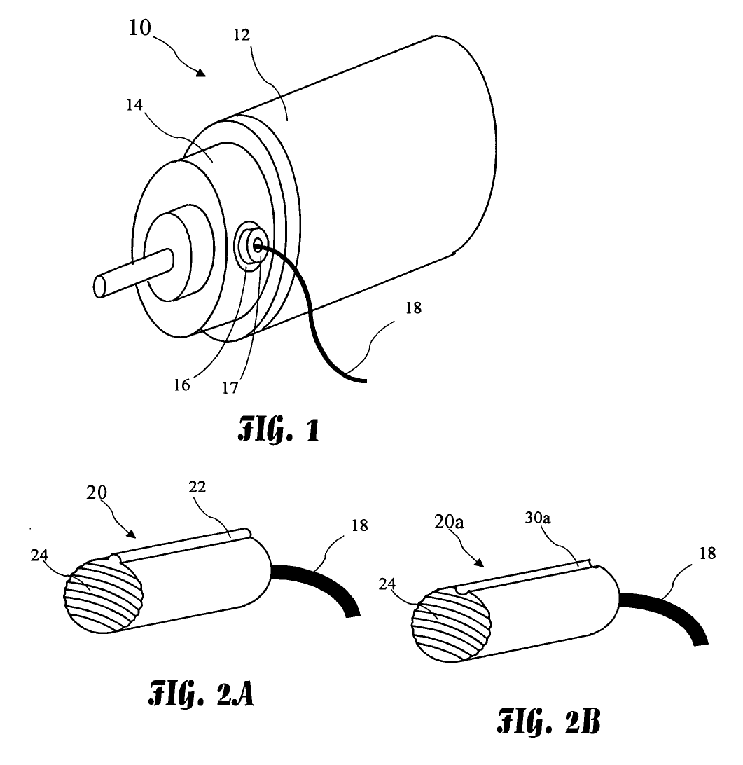

An electric motor 10 having round keyed brushes is shown in FIG. 1. The motor 10 includes a case 12, an end bell 14, brush guides 16, brush caps 17, and shunt wire 18. The brush caps 17 hold a spring against brushes 20 (see FIG. 2) to maintain force on the brushes 20.

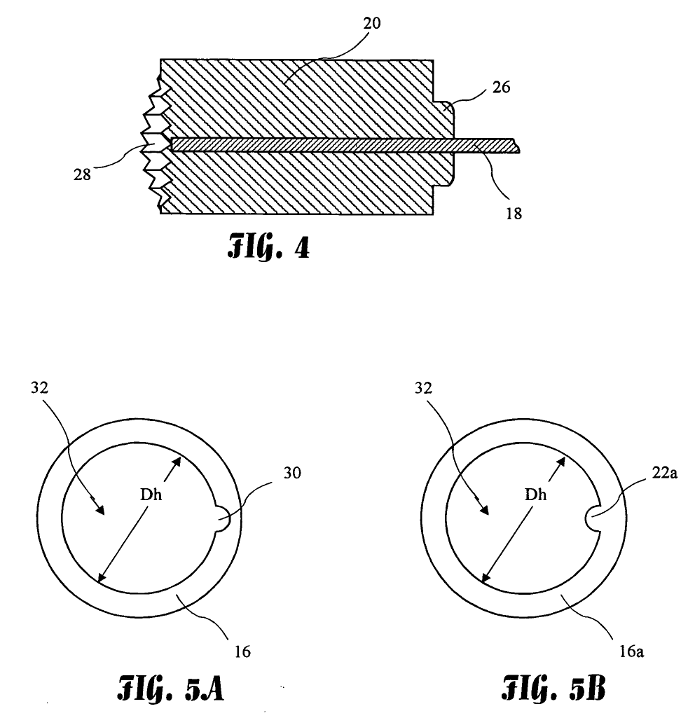

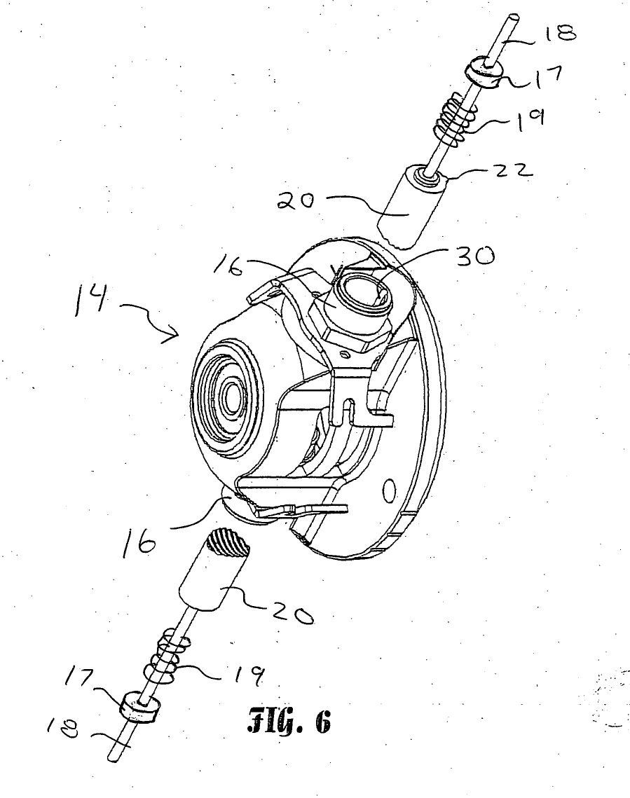

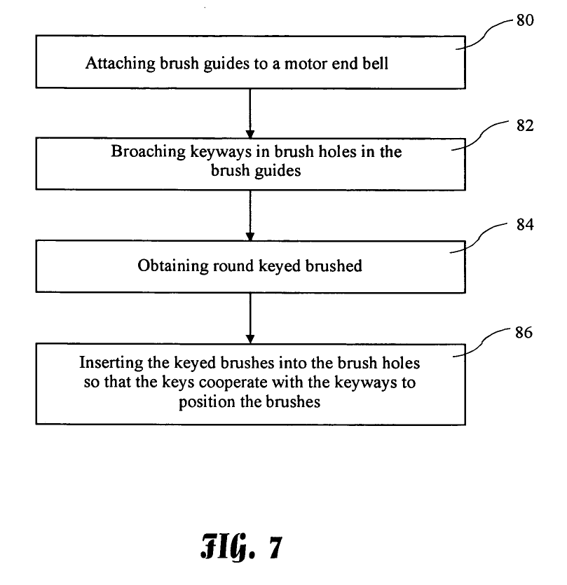

A perspective view of a round keyed brush 20 for use with the motor 10, is shown in FIG. 2A. The round brush 20 includes a key 22 for cooperating with a keyway 30 in the brush guide 16 (see FIG. 5) to rotationally positioning the round brush. An arced face 24 cooperates with a motor commutator, and includes a plurality of grooves to facilitate break-in. The shunt wire 18 is electrically connected to the round brush 20 to carry electricity to the round brush 20. While the key 22 is shown running the length of the brush 20, the key 22 may also run a portion of the brush length, or be broken into segments. There also may be two or more keys 22 on each brush 20.

The round brush may also be embodied in a second round brush 20a as shown in FIG. 2B. The round brush 20a includes a second keyway 30a which cooperates with a second key 22a (see FIG. 5B). While rounded (or semi-circular) keys and keyways have been described above, the present invention may be exercised using any shape key and keyway, and any electric motor with round brushes, which motor includes cooperating keys and keyways to rotationally position the round brushes, is intended to come within the scope of the present invention.

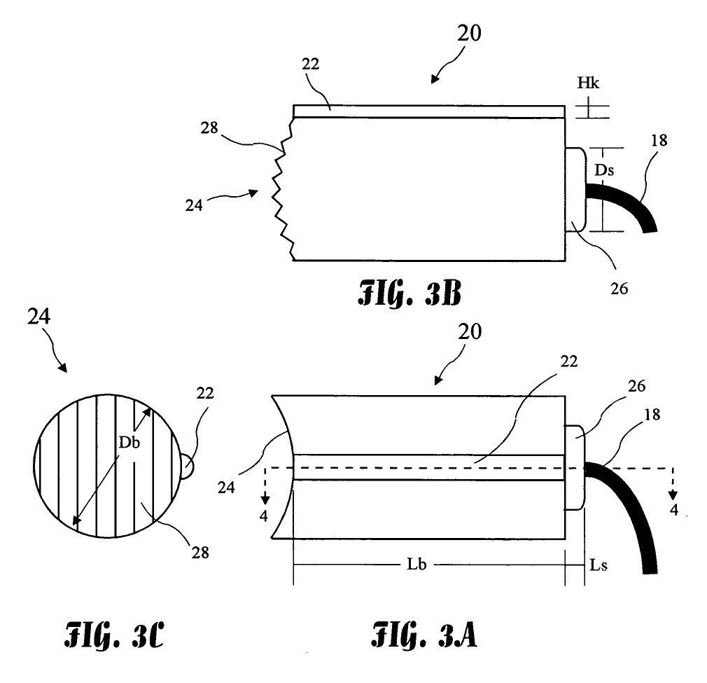

A side view of the round keyed brush 20 is shown in FIG. 3A, a top view of the round keyed brush 20 in FIG. 3B, and a face view of the round keyed brush 20 in FIG. 3C. The face 24 is curved to match the curvature of the motor commutator. The grooves 28 run in the direction of rotation of the commutator. A step 26 is formed on the end of the brush 20 opposite the face 24, which step 26 may aid in positioning the spring 19 (see FIG. 6) behind the brush 20. The key 22 runs parallel with the main axis of the brush 20, and preferably runs the entire length of the brush 20, or substantially the entire length of the brush 20. The brush 20 is preferably a sintered brush and is preferably made from a combination of carbon and copper and/or silver.

A preferred application of the present invention is in a motor used in Remote Control (RC) cars, and more particularly in RC racing cars. A brush 20 suitable for RC race cars preferably has a brush length Lb of approximately 0.325 inches and a brush diameter Db of approximately 0.174 inches to approximately 0.176 inches. The brush face 24 preferably has a curvature with a 0.31 inch radius. The key 22 preferably has an approximately semi-circular cross-section, and preferably has a radius of approximately 0.015 inches, or preferably extends approximately 0.015 inches from the round brush 20. The grooves 28 are preferably approximately 0.10 inches deep and are spaced approximately 0.023 inches apart on the face 24. The step 26 has a diameter Ds which is preferably approximately 0.103 inches, and a depth which is preferably approximately 0.025 inches.

While an RC race car motor is a preferred use, the present invention is suitable for a variety of electric motors, and any electric motor with round brushes and a cooperation of a key with a keyway to rotationally position the brushes, is intended to come within the scope of the present invention.

A cross-sectional view of the round keyed brush taken along line 4-4 of FIG. 3A is shown in FIG. 4. The shunt wire 18 is axially centered in the brush 20 and runs substantially the entire length of the brush 20.

An end view of the brush guide 16, brush hole 32, and keyway 30 is shown in FIG. 5A. The brush hole 32 diameter Dh is preferably approximately 0.176 inches to approximately 0.179 inches. The brush diameter and brush hole diameter may vary, but preferably, the brush hole diameter Dh is approximately 0.002 inches to approximately 0.003 inches greater than the brush diameter Db.

A second brush guide 16a is shown in FIG. 5B. The brush guide 16a includes a second key 22a which cooperates with the second keyway 30a (see FIG. 2B).

A detailed view of the end bell 14 with brush guides 16 and with the brushes 20 removed from the brush guides 16 is shown in FIG. 6. The brush guides 16 are on opposite sides of the end bell 14, and are approximately co-axial (i.e., within reasonable manufacturing tolerances). In a preferred embodiment the keys 22 are to the rear (i.e., pointed toward the case 12). The brush guides 16 are preferably made from copper or aluminum, and more preferably from copper. The brush guides preferably screw into the end bell 14 which is preferably made from aluminum, and anodized to electrically insulate the brush guides 16 from each other. The brushes 20 are held against the commutator by springs 19 which are held in place by brush caps 17. The brush caps 17 preferably screw onto the brush guides 16.

Alternatively, the end cap may be plastic. The brush guides may be formed in the end cap, or threaded holes may be cast into the plastic end cap to attach the brush guides. In a preferred embodiment, threads are formed half way through the end cap, leaving an un-threaded region having a diameter to create interference with a brush guide, thereby holding the brush guide in place.

While the embodiment described in FIG. 6 includes brush guides which are separate parts which are attached to an end bell, in other embodiments, the brush guides may be machined, cast, or in some other way formed directly as part of the end bell. Any motor having round keyed brushes and brush holes with keyways, wherein the keys cooperate with the keyways to rotationally position the brushes in the brush holes, is intended to come within the scope of the present invention, regardless of the of how the brush holes and keyways are formed, and regardless of what structure of the motor defines the brush holes and keyways.

FIG. 7 is a method for constructing the motor with round keyed brushes. The method comprises attaching brush guides to a motor end bell, where in the brush guides have brush holes, broaching keyways in the brush holes, obtaining round sintered brushes having keys, and inserting the keyed brushes into the brush holes so that the keys cooperate with the keyways to rotationally position the brushes. Attaching the pair brush guides in a motor end bell preferably comprises screwing the brush guides into the end cap and using a high temperature locking material to hold the brush guides in place, and forming sintered brushes having keys preferably comprises forming sintered brushes from carbon combined with at least one material selected from the group consisting of copper and silver.

While the invention herein disclosed has been described by means of specific embodiments and applications thereof, numerous modifications and variations could be made thereto by those skilled in the art without departing from the scope of the invention set forth in the claims.

I claim:

1. An electric motor having a case, magnets residing in the case, an armature inside the case, and an end bell at one end of the case, the improvement comprising:
brush guides having brush holes, wherein the brush guides are selected from the group consisting of brush guides attached to the end bell and brush guides molded into the bell ends; and
round brushes adapted to slide axially within the brush holes,
wherein the round brushes are keyed to the brush holes to rotationally position the round brushes by cooperation of keys with keyways.

2. The electric motor of claim 1, wherein the brush holes comprise two round brush holes which are approximately co-axial.

3. The electric motor of claim 1, wherein the keyways reside in the brush holes.

4. The electric motor of claim 3, wherein the keyways are formed in the brush holes by broaching.

5. The electric motor of claim 1, wherein the round brushes are round sintered brushes.

6. The electric motor of claim 1, wherein the round brushes are formed from carbon and at least one material selected from the group consisting of copper and silver.

7. The electric motor of claim 1, wherein the keys run substantially the length of the round brushes.

8. The electric motor of claim 1, wherein the round brushes include a grooved face to facilitate break-in of the round brushes.

9. The electric motor of claim 1, wherein the round brushes include a braided copper shunt wire running substantially the length of the round brush.

10. The electric motor of claim 1, wherein the round brushes are approximately 0.325 inches long and approximately 0.174 inches to approximately 0.176 inches in diameter.

11. The electric motor of claim 1, wherein the key extends approximately 0.015 inches from the round brush.

12. The electric motor of claim 1, wherein the key has a semicircular shape with an approximately 0.015 inch radius.

13. The electric motor of claim 1, wherein the brush guides are molded into the end cap.

14. The electric motor of claim 1, wherein the brush guides are attached to the end cap, and wherein the brush guides are made from a material selected from the group consisting of copper and aluminum.

15. The electric motor of claim 1, wherein the brush guides are attached to the end cap, and wherein the brush guides are made from copper.

16. The electric motor of claim 1, wherein the end cap is made from anodized aluminum.

17. An electric motor comprising:
a case;
magnets residing in the case;
an armature inside the case;
an end bell on one end of the case;
approximately coaxial brush guides positioned by the end bell, and having brush holes with keyways; and
round keyed sintered brushes adapted to slide axially within the brush holes and to be rotationally fixed in position by cooperation of keys formed on the brushes with the keyways.

18. A method for manufacturing a round keyed brush electric motor, the method comprising:
attaching brush guides to a motor end bell, wherein the brush guides have brush holes;
broaching keyways in the brush holes;
providing round sintered brushes having keys; and
inserting the keyed brushes into the brush holes wherein the keys cooperate with the keyways to align the brushes.

19. The method of claim 18, wherein attaching the brush guides in a motor end bell comprises screwing the brush guides into the end bell and using a high temperature locking material to hold the brush guides in place.

20. The method of claim 18, wherein forming sintered brushes having keys comprises forming sintered brushes from carbon combined with at least one material selected from the group consisting of copper and silver.
